(19) United States
(12) Patent Application Publication
(10) Pub. No.: US 2025/0313355 A1
(43) Pub. Date: Oct. 9, 2025

(54) UNMANNED AIRCRAFT

(71) Applicant: Kubota Corporation, Osaka (JP)

(72) Inventor: Kohei SEINO, Sakai-shi (JP)

(21) Appl. No.: 19/246,741

(22) Filed: Jun. 24, 2025

Related U.S. Application Data
(63) Continuation of application No. PCT/JP2022/048161, filed on Dec. 27, 2022.

(51) Int. Cl. B64U 10/14; B64U 50/11; B64U 50/19; B64U 50/23; B64U 50/33

(52) U.S. Cl. CPC B64U 10/14; B64U 50/11; B64U 50/19; B64U 50/23; B64U 50/33; B64U 2201/10

(57) ABSTRACT

An unmanned aerial vehicle includes a plurality of electric motors each to drive a respective one of a plurality of first rotors included in a plurality of rotors, an internal combustion engine, an electric generator that is driven by the internal combustion engine to generate electric power, a battery to store the electric power, and a controller configured or programmed to control flight of the unmanned aerial vehicle and to change an upper limit of a flight altitude of the unmanned aerial vehicle according to a charging state of the battery.

### CROSS REFERENCE TO RELATED APPLICATIONS

This application claims the benefit of priority to Continuation Application of PCT Application No. PCT/JP2022/048161 filed on Dec. 27, 2022. The entire contents of this application are hereby incorporated herein by reference.

### BACKGROUND OF THE INVENTION

### 1. Field of the Invention

The present disclosure relates to unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2022-104737 describes an unmanned aerial vehicle (unmanned flying body) that changes its flight position in coordination with the operation of an agricultural machine.

### SUMMARY OF THE INVENTION

The maximum payload capacity (payload) and flight duration of unmanned aerial vehicles may be insufficient depending on the application, and further improvements are desired.

Example embodiments of the present disclosure provide unmanned aerial vehicles each capable of increasing payload and/or flight duration.

In a non-limiting example embodiment of the present disclosure, an unmanned aerial vehicle includes a plurality of rotors, a plurality of electric motors each to drive a respective one of a plurality of first rotors included in the plurality of rotors, an internal combustion engine, an electric generator driven by the internal combustion engine to generate electric power, a battery to store the electric power, and a controller is configured or programmed to control flight of the unmanned aerial vehicle and to change an upper limit of a flight altitude of the unmanned aerial vehicle according to a charging state of the battery.

According to example embodiments of the unmanned aerial vehicles of the present disclosure, it is possible to land using power stored in the battery even in situations where electric power is not being generated by the electric generator.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drive devices to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3 is a block diagram showing a basic configuration example of an unmanned aerial vehicle (multicopter) according to an example embodiment of the present disclosure.

FIG. 4 is a diagram schematically showing a charging state of a battery.

FIG. 5 is a diagram schematically showing an example of the relationship among the state of charge (SOC) of a multicopter, maximum height MH, and flight altitude FH.

FIG. 6 is a flowchart showing an example of an operation of a controller according to an example embodiment of the present invention.

FIG. 7 is a diagram schematically showing an example of correcting the upper limit of flight altitude according to the terrain directly below the multicopter in an example embodiment of the present invention.

FIG. 8 is a diagram schematically showing another example of correcting the upper limit of flight altitude according to the terrain directly below the multicopter in an example embodiment of the present invention.

FIG. 9 is a plan view showing an example of the positional relationship between a multicopter flying over a field and possible landing points existing around the field.

FIG. 10 is another plan view showing an example of the positional relationship between a multicopter flying over a field and possible landing points existing around the field.

FIG. 11 is yet another plan view showing an example of the positional relationship between a multicopter flying over a field and possible landing points existing around the field.

FIG. 12 is a flowchart showing another example of an operation of a controller according to an example embodiment of the present invention.

FIG. 13 is a block diagram showing an example of the hardware configuration of a controller in an example embodiment of the present invention.

FIG. 14 is a diagram schematically showing an example of a communication network to which the multicopter in an example embodiment of the present invention is connected.

### DETAILED DESCRIPTION OF THE EXAMPLE EMBODIMENTS

Unmanned aerial vehicles each include a plurality of rotors and a rotation driver to rotate the rotors (hereinafter referred to as “propellers”). Hereinafter, such an unmanned aerial vehicle is referred to as a “multicopter”.

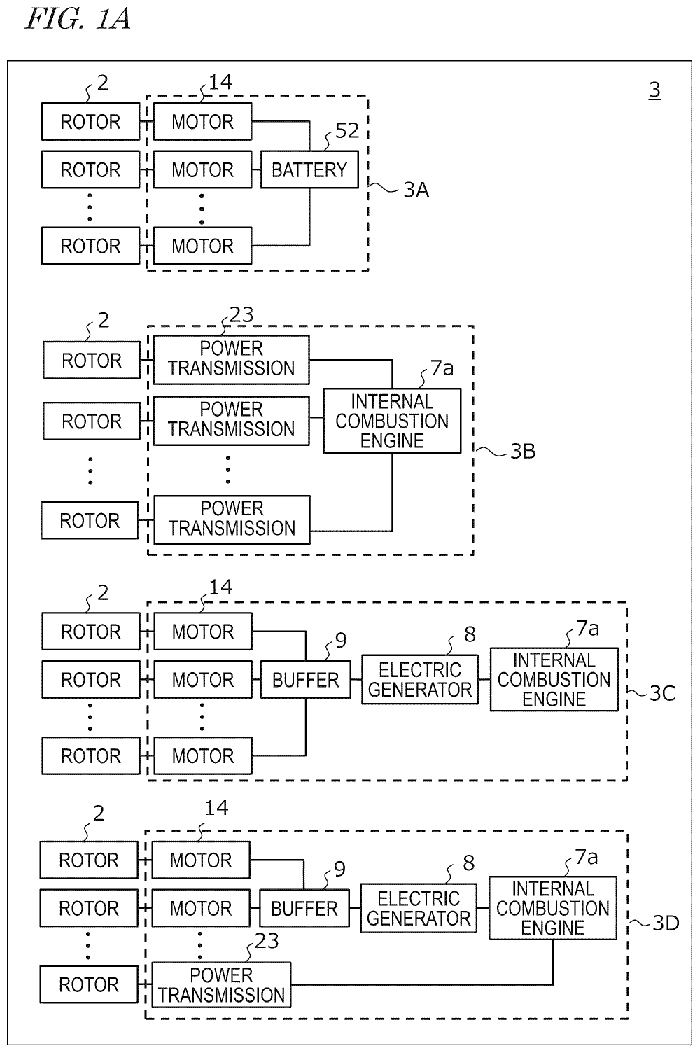

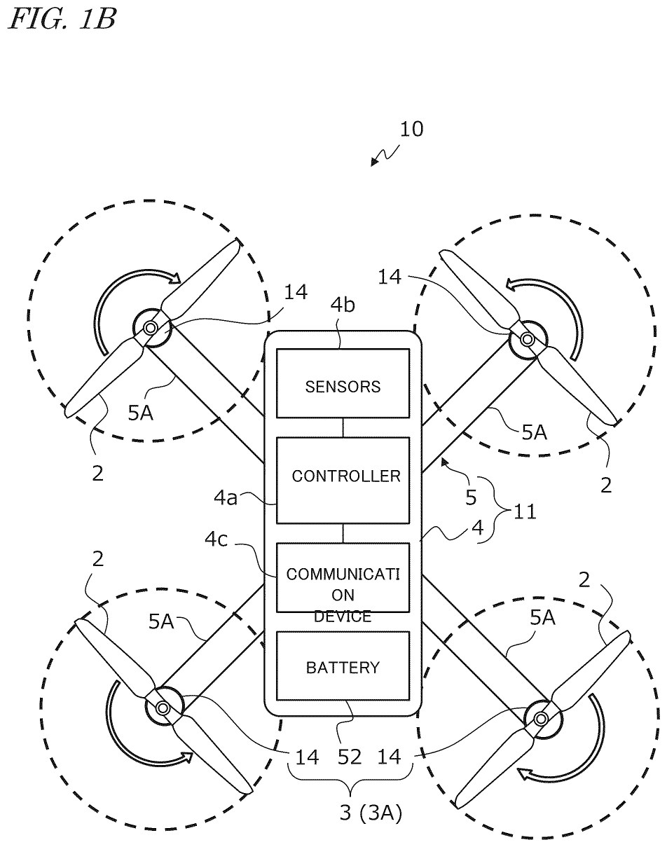

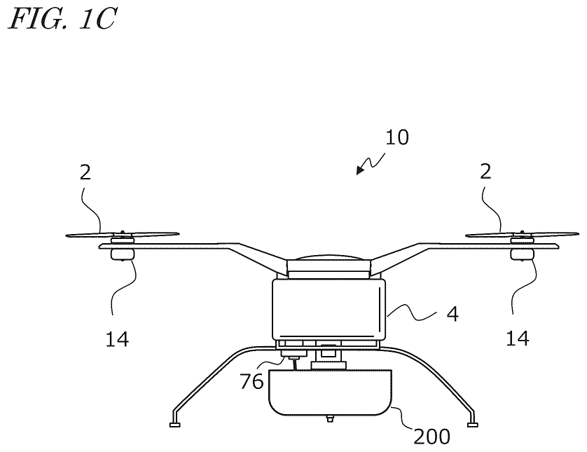

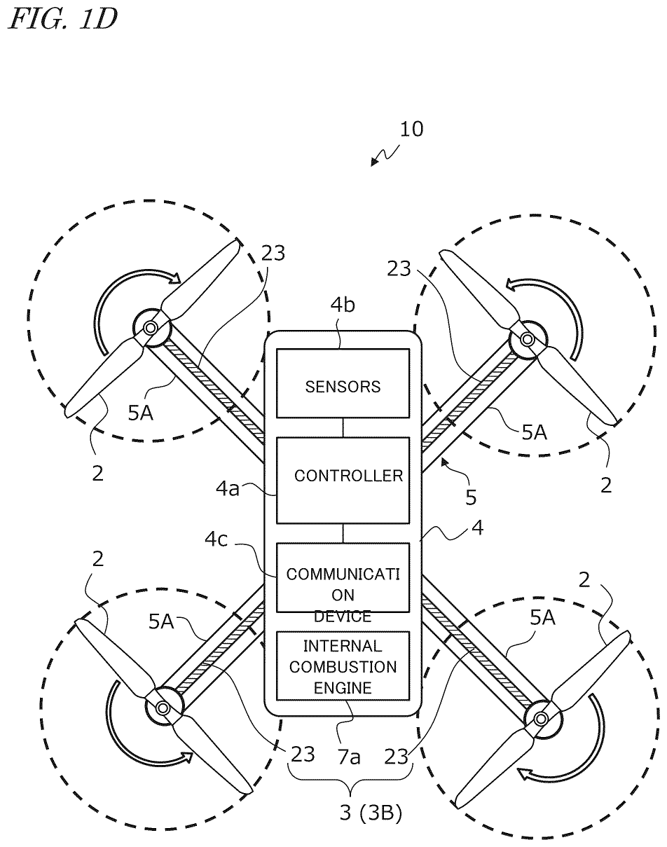

The configuration of rotation drivers included in multicopters exists in various forms. FIG. 1A is a schematic block diagram showing four examples of rotation driver 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is desirable to increase the power storage capacity of battery 52. While the power storage capacity of battery 52 can be increased by making battery 52 larger, enlarging battery 52 leads to an increase in weight. The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of drive is called a “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of drive is called a “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A.

In the example of FIG. 1B, the multicopter 10 is a quad-type multicopter (quadcopter) including four rotors 2, for example. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imaging device, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used for measuring distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured or programmed to receive signals such as control commands transmitted from the ground and transmit sensor data such as image data acquired by sensors 4b as telemetry information. The communication device 4c may also include functions for communication between unmanned aerial vehicles and satellite communication capabilities. The controller 4a may connect to computers in the cloud through the communication device 4c. The cloud-based computer may execute part or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust. Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are equipped, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned more inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid drive, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used for generating thrust, and the sub-rotors are used for both generating thrust and attitude control. The main rotors may be called “booster rotors” and the sub-rotors may be called “attitude control rotors”.

In the parallel hybrid drive, the internal combustion engine is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt a parallel hybrid driver or a series hybrid driver to increase payload and flight duration.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area.

In the example shown in FIG. 1C, the multicopter 10 includes a power supply 76. The power supply 76 supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery to store power.

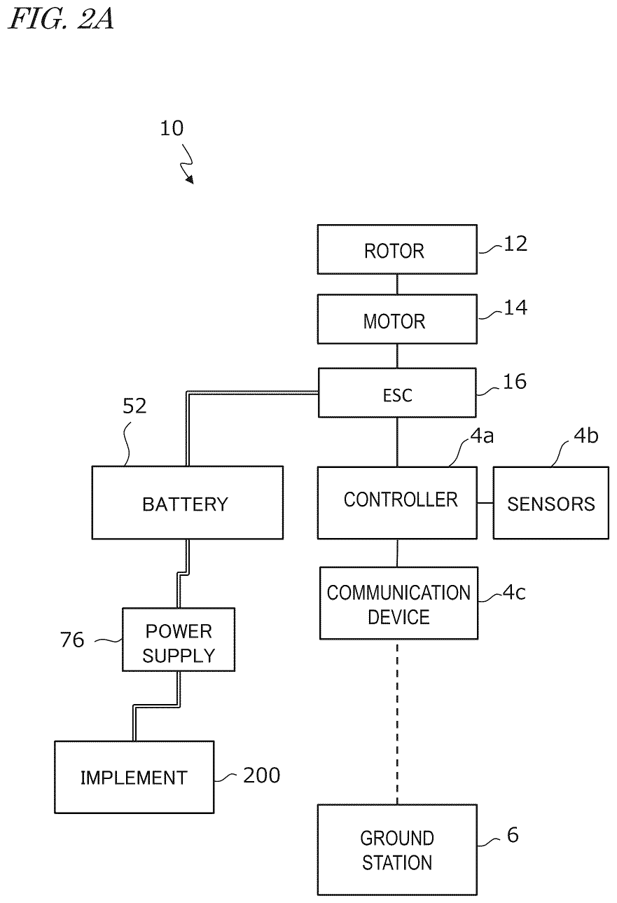

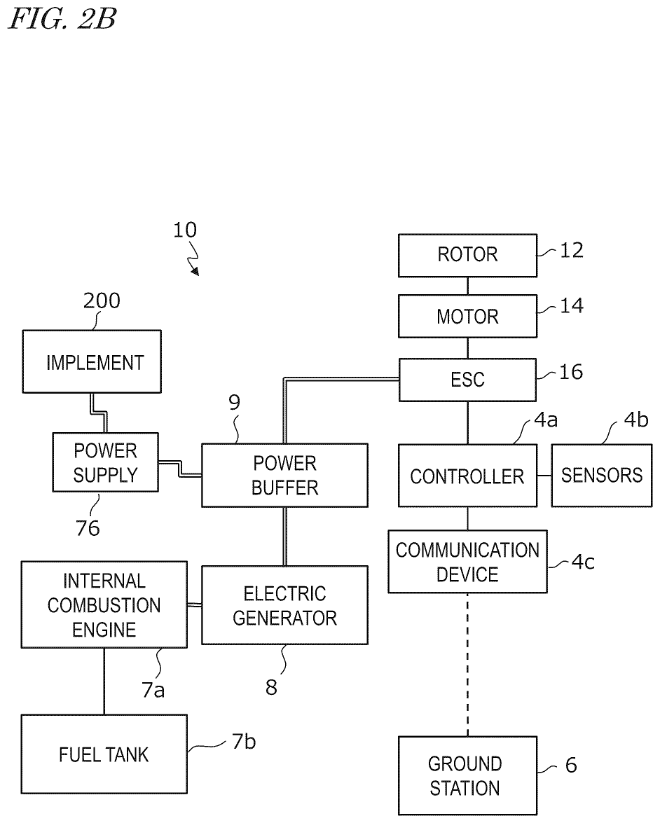

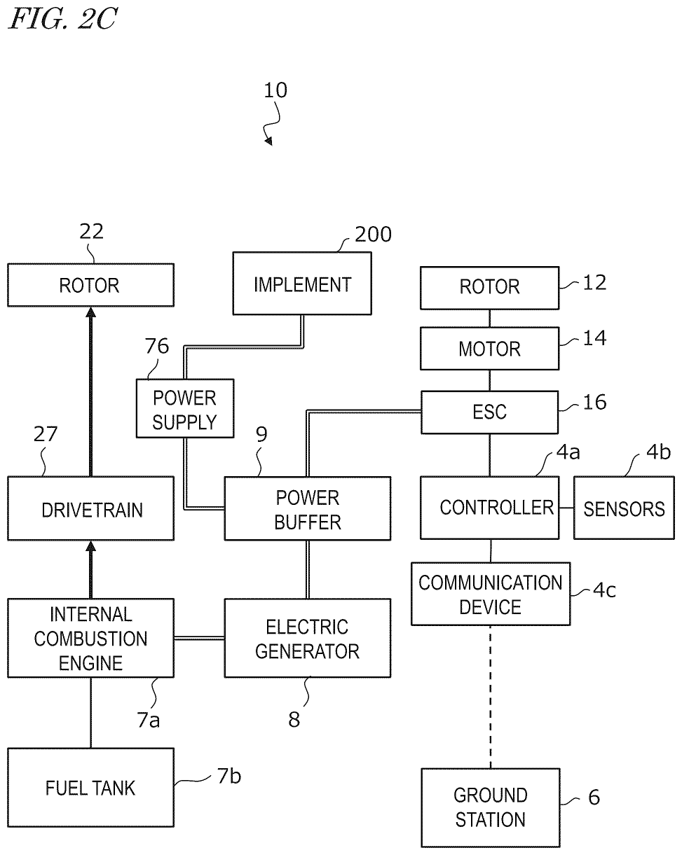

FIG. 2A is a block diagram showing a basic configuration example of a battery-driven multicopter 10.

The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. The same applies to FIGS. 2B and 2C.

The controller 4a may receive control commands wirelessly from, for example, a ground station 6 on the ground through the communication device 4c. The number of ground stations 6 is not limited to one, and the ground station 6 may be distributed across a plurality of locations. The communication device 4c may also wirelessly receive control commands from an operator's controller on the ground. The controller 4a may have functions to automatically or autonomously execute takeoff, flight, obstacle avoidance, and landing operations based on sensor data obtained from the sensors 4b. The controller 4a may be configured to communicate with the implement 200 connected to the power supply 76 and obtain signals indicating the state of the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless devices or methods.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid type multicopter 10. Like the series hybrid type multicopter 10, the parallel hybrid type multicopter 10 includes a plurality of rotors 12, a plurality of motors 14, a plurality of ESCs 16, a controller 4a, sensors 4b, a communication device 4c, an internal combustion engine 7a, a fuel tank 7b, an electric generator 8, a power buffer 9, and a power supply 76. The parallel hybrid type multicopter 10 further includes a drivetrain 27 that transmits driving force from the internal combustion engine 7a, and a rotor 22 that rotates upon receiving driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

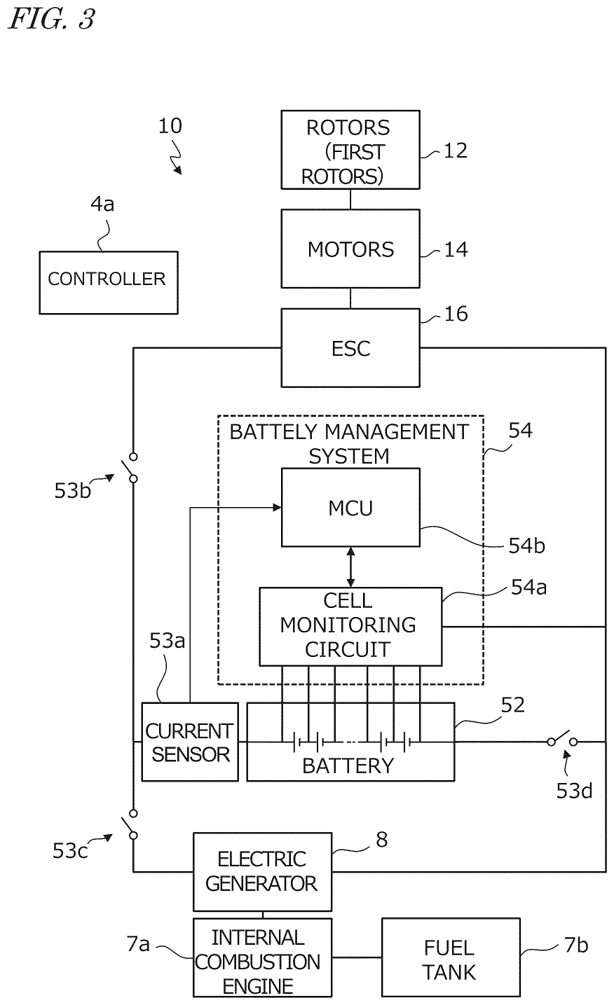

The following describes a basic configuration example of an unmanned aerial vehicle (multicopter) according to an example embodiment of the present disclosure with reference to FIG. 3.

In the example shown in FIG. 3, the multicopter 10 broadly includes a plurality of rotors (first rotors) 12, a plurality of motors 14 each driving a respective one of the plurality of first rotors 12, an internal combustion engine 7a, an electric generator 8 driven by the internal combustion engine 7a to generate electric power, a battery 52 that stores electric power, and a controller 4a that controls flight of the multicopter 10. In FIG. 3, for simplicity, the rotor 12, the motor 14, and the ESC 16 are each shown by a single block, but the numbers of rotors 12, motors 14, and ESCs 16 are each plural. Also, although not shown in FIG. 3, the multicopter 10 may include at least one second rotor 22 driven by the internal combustion engine 7a, as shown in FIG. 2C. The present example embodiment may adopt either “series hybrid” or “parallel hybrid” drive formats.

The multicopter 10 according to the present example embodiment includes a current sensor 53a that measures current flowing through battery 52, and switch elements 53b, 53c, 53d that define the current path during discharge and charge of battery 52. During charging, current flows from the electric generator 8 to the battery 52 through the closed switch elements 53c, 53d. During discharging, current flows from the battery 52 to the ESCs 16 and motors 14 through the closed switch elements 53b, 53d. The multicopter 10 may further include other switch elements and/or current sensors. The opening and closing of switch elements 53b, 53c, 53d may be controlled by the controller 4a.

The multicopter 10 according to the present example embodiment includes a battery management system 54 that monitors and manages the battery 52. The battery management system 54 includes a cell monitoring circuit 54a that monitors the state (voltage and temperature, etc.) of each of a plurality of single cells included in the battery 52, and a microcontroller (Microcontroller Unit: MCU) 54b configured or programmed to estimate the charging state of the battery 52 and execute battery management operations.

The cell monitoring circuit 54a may be configured to measure the voltage of each cell and execute cell balancing during charging. The cell monitoring circuit 54a may include a protection circuit that prevents overcharging and over-discharging of each cell. Such protection circuits may be provided in battery packs that each include a plurality of cells.

The MCU 54b may be configured or programmed to execute various calculations to estimate, for example, the state of charge (SOC) of the battery 52. The state of charge (SOC) is one of the state variables that define the charging state of the battery 52. The state variables that define the charging state of the battery 52 are not limited to the state of charge and may include variables such as the State Of Health (SOH) and Full Charge Capacity (FCC).

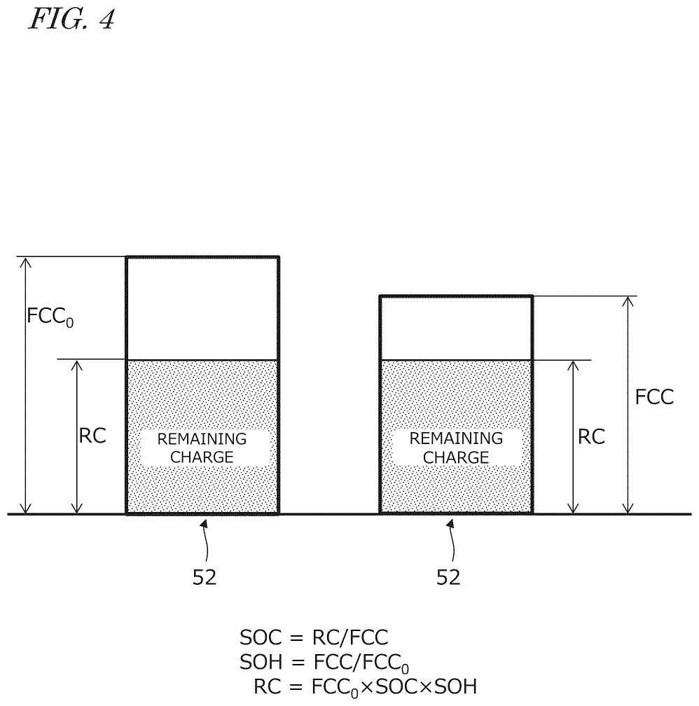

FIG. 4 is a diagram schematically showing a charging state of a battery 52. The left portion of FIG. 4 shows the charging state of a battery 52 in its initial state, and the right portion shows the charging state of a battery 52 with a decreased full charge capacity (FCC) due to deterioration. The state of charge (SOC) is equal to the Remaining Charge (RC) of battery 52 divided by the Full Charge Capacity (FCC), that is, RC/FCC. The state of charge (SOC) defined in this way may sometimes be called “Relative SOC (RSOC)”.

The State Of Health (SOH) and Full Charge Capacity (FCC) decrease as the battery 52 deteriorates. If the initial full charge capacity is denoted as FCC₀, the relationship between SOH and FCC is SOH=FCC/FCC₀. In the initial state, the SOH is 1.0.

The Remaining Charge (RC), which defines the amount of power stored in the battery 52, is equal to SOC×SOH×FCC₀. Since FCC₀ is known, if the estimated values of SOC and SOH are determined, RC can be calculated. The distance that can be flown using only the power stored in battery 52 depends not only on RC but also on the State Of Power (SOP), which depends on the magnitude of the current flowing through battery 52 (C-rate) and the temperature of battery 52, among other factors. In particular, the temperature of the battery affects the distance that the multicopter 100 can fly using the power stored in the battery 52, or the maximum height from which it can descend and land. Therefore, it is preferable for the controller 4a to determine the maximum height based on the estimated state of charge of the battery 52 and the measured temperature of the battery 52. Specifically, multiple tables defining the relationship between the state of charge of the battery 52 and the maximum height can be stored for different battery temperatures in, for example, a storage device included in the controller 4a. Then, the table for the battery temperature closest to the measured temperature of the battery 52 can be selected, and the maximum height can be read from that table based on the state of charge.

After the charging state of the battery 52 (state of charge SOC, state of health SOH, battery temperature, etc.) is estimated by the battery management system 54, the controller 4a can perform necessary calculations based on those estimated values and calculate the possible flight time using the power of the battery 52. The possible flight time can be calculated by dividing the amount of power stored in the battery 52 by the power consumption per unit time (power consumption) of the multicopter 100 during flight. For example, if the amount of power stored in the battery 52 is 1.5 kWh and the power consumption of the multicopter 100 during flight is 30 KW, the possible flight time is 1.5 kWh/30 kW=0.05 h=3 minutes. The power consumption varies depending on the multicopter 100 and also depends on the payload of the multicopter 100. For example, in a multicopter 100 where power consumption increases by 5 KW for every 10 kg increase in payload value, if the payload value is in the range of 30-40 kg, a maximum increase in power consumption of about 5 KW×4=20 KW can be expected. Taking this increase into account, the 3-minute possible flight time in the above example would be corrected to 1.5 KW/50 KW=0.03 h=1.8 minutes (1 minute 48 seconds), for example.

In an example embodiment, the controller 4a stores a table or function defining the relationship between power consumption and payload value.

When the controller 4a calculates the possible flight time, it may acquire information about weather conditions including wind speed and correct the possible flight time based on that information. When the multicopter 100 flies along a predetermined path, it consumes extra power to resist the force of the wind. Therefore, power consumption increases as wind speed increases. The relationship between wind speed and power consumption can be determined in advance for each multicopter 100 and stored in the storage device of the controller 4a. The state of charge (SOC) that defines the charging state of the battery 52 can be estimated using various algorithms. For example, the following algorithms can be adopted:

Measure the voltage (terminal voltage) of the battery 52 and estimate the state of charge (SOC) from that measured value. The measured values of the current flowing through the battery 52 and the temperature of the battery 52 are referenced in the estimation.

Integrate the current flowing through the battery 52 to determine the charge that has entered and exited the battery 52, and obtain an estimated value of the remaining charge (RC) (Coulomb counting method).

Utilize the relationship between the Open Circuit Voltage (OCV) of the battery and the state of charge (SOC), and estimate the state of charge (SOC) from the measured values of current and voltage based on a model that includes the open circuit voltage (OCV) and battery internal impedance. Sequential Bayesian filters such as Kalman filters may be used for this estimation.

The estimation of the state of charge (SOC) is not limited to the above examples, and any method may be adopted. Also, the estimation of the state of health (SOH) and other state variables or parameters may be executed by any method/algorithm.

In the example of FIG. 3, the battery 52 can be charged by the electric generator 8 being driven by the internal combustion engine 7a. Therefore, in this example embodiment, when estimating the possible flight time, the controller 4a can estimate the possible flight time based on, for example, the amount of fuel consumed during 1 minute of flight and the amount of fuel stored in the fuel tank 7b (fuel remaining). The amount of fuel consumed during 1 minute of flight may also vary depending on the payload of the multicopter 10 and weather conditions, but it can be calculated by the controller 4a based on measured values obtained in real-time by a fuel gauge and timer mounted on the multicopter 10, and can be updated at any time. When an implement 200 is connected to the multicopter 100, since an appropriate implement 200 is selected from various implements according to the agricultural work, the payload may vary depending on the type or model of the implement 200. The payload also changes when the multicopter 100 transports harvested crops or agricultural materials. Therefore, when the controller 4a estimates the possible flight time, it is desirable for the controller 4a to acquire information indicating additional weight separate from the weight of the multicopter 100 itself, and to use this information to improve the estimation accuracy of the possible flight time.

Consider an example where the multicopter 10 flies from its current position to a point P that is a distance X [meter] away, and then descends and lands on the ground at position P. Let the average flight speed of the multicopter 10 be Sf [meter/second], the flight altitude at position P be h [meter], and the average descent speed from the airspace above position P (altitude=h) until landing be Sd [meter/second]. In this case, the time required to fly from the current position to the airspace above position P, converted to minutes, is X/(60×Sf). Also, the time required to descend and land from flight altitude h at position P to the ground at height 0, converted to minutes, is h/(60×Sd). Thus, we will call the time from the current position to flying to a point X distance away and landing at that position the “flight landing time (Tfd)”. The equation Tfd=X/(60×Sf)+h/(60×Sd) holds.

In this disclosure, if Y is the possible flight time of the multicopter 10, the flight is controlled such that Y>Tfd holds. For example, if the distance X from the current position of the multicopter 10 to the nearest possible landing point is 1200, and Sf=2, h=60, Sd=0.5, then Tfd=1200/(60×2)+60/(60×0.5)=10+2=12 minutes. If the possible flight time Y of the multicopter 10 at the current position is greater than 12 minutes, it can land at a point that is distance X away from the current position.

In the present example embodiment of the present disclosure, the altitude h before starting the landing operation is varied according to the charging state of the battery 52, as described later. If the altitude h changes, the time required to descend and land from the altitude h also changes. Also, even with the same altitude h, the appropriate descent speed Sd may need to be changed due to changes in weather conditions such as wind speed during landing. Therefore, for the time required for landing, instead of calculating based on various elements including altitude h, it is preferable to adopt a fixed value such as 3 minutes. Below, the flight landing time (Tfd) is expressed by the following equation (1) using the distance X and the average flight speed Sf.

$$Tfd = X / ( 60 \times Sf ) + 3 \qquad ( Equation 1 )$$

In this example embodiment, since the multicopter 10 includes an internal combustion engine 7a and generates power using the electric generator 8, the possible flight time is extended compared to a battery-driven multicopter that flies only with the power initially stored in the battery 52. Due to the internal combustion engine 7a, it is necessary to mount a fuel tank 7b on the multicopter 10 to store fuel, but the output energy relative to fuel weight is higher than the output energy relative to battery 52 weight. Therefore, in the present example embodiment of the present disclosure, it is possible to increase the possible flight time or payload by making the full charge capacity of the battery 52 relatively small to achieve weight reduction, while utilizing the internal combustion engine 7a, fuel tank 7b, and electric generator 8.

In the multicopter 10 of this example embodiment, the battery 52 functions as a power buffer to supply power generated by the electric generator 8 to the motor 14, as well as a kind of safety device in case of failure of the internal combustion engine 7a or electric generator 8. That is, when the internal combustion engine 7a or electric generator 8 fails, a state occurs where the electric generator 8 cannot generate new power, but the power stored in the battery 52 can be used to rotate the motor 14 and rotor 12, allowing the multicopter 10 to land.

In this example embodiment, the full charge capacity (FCC) of the battery 52 has a size that allows the multicopter 10 to descend from a specified reference height to the ground and land using the power stored in the battery 52 when power is not being generated by the electric generator 8. This reference height is in the range of at most 10 m to 300 m, for example, up to 200 m. It is also possible to further increase the full charge capacity (FCC) of the battery 52, but an excessive weight increase of the battery 52 is not desirable. The full charge capacity (FCC) of the battery 52 is sufficient if it is at a level that enables flight (descent) for the time required for landing (for example, 3 minutes) in a situation where the electric generator 8 cannot generate power.

However, the charging state of the battery 52 is not always at full charge (SOC=1.0). When the battery 52 includes lithium-ion batteries, for example, the state of charge varies in the range of 0.3 to 0.9. Since lithium-ion batteries may deteriorate due to over-discharge and overcharge, it is preferable that the state of charge (SOC) is controlled to be maintained within a predetermined range, for example, within the range of 0.5 to 0.85, by charging and discharging. Such control of charging and discharging is realized by the operation of the battery management system 54 and controller 4a shown in FIG. 3.

An example where, when lowering the altitude of the multicopter 10 by 2 m at a predetermined speed for landing, power is consumed by the descent operation, and the state of charge (SOC) of the battery 52 decreases by 1%, will be explained. In this example, if the state of charge (SOC) at the start of descent is 100% (fully charged), it is possible to lower the altitude by 200 m. In this case, even if the flight altitude is 200 m, landing is possible with just the power stored in the battery 52. However, if the state of charge (SOC) at the start of descent is 50%, the multicopter 10 can only lower its altitude by 100 m, for example, and a multicopter 10 flying at an altitude exceeding 100 m would not be able to land.

To solve such a problem, in the multicopter 10 of this example embodiment, the controller 4a is configured or programmed to change the upper limit of the flight altitude of the multicopter 10 according to the charging state of the battery 52. This point will be explained in detail below.

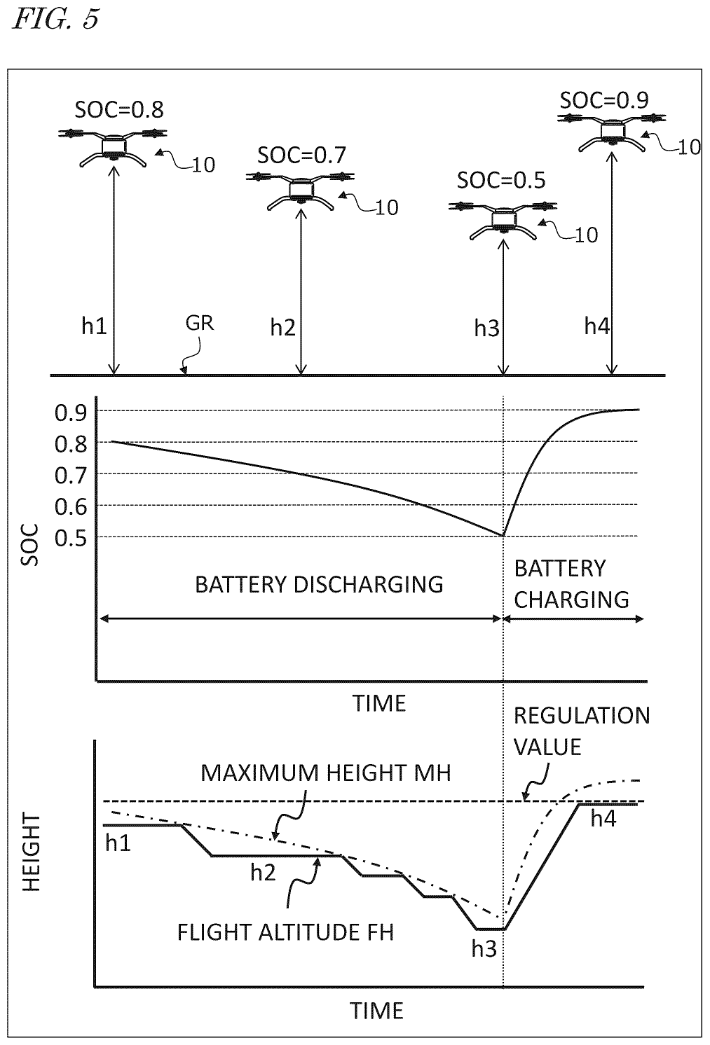

First, refer to FIG. 5. The upper portion of FIG. 5 schematically shows the flight altitude of the multicopter 10 in a case where the state of charge (SOC) of the battery 52 gradually decreases from 0.8 to 0.5, and then rises to 0.9 due to charging by the electric generator 8, for example.

When the state of charge (SOC) is 0.8, for example, the multicopter 10 is flying at a height h1 from the ground GR. In other words, the flight altitude (FH) at this time is h1. When the state of charge (SOC) is 0.7, the flight altitude (FH) of the multicopter 10 is h2, and when the state of charge (SOC) is 0.5, the flight altitude (FH) of the multicopter 10 is h3, for example.

The middle portion of FIG. 5 shows an example of the temporal change in the state of charge (SOC) of the battery 52. During battery discharge, power stored in the battery 52 is consumed by the rotation of motors 14 and rotors 12, etc., and the state of charge (SOC) gradually decreases. In contrast, during battery charging, power generated by the electric generator 8 is stored in the battery 52, and the state of charge (SOC) increases. The battery management system 54 in this example embodiment operates to charge the battery 52 with power generated by the electric generator 8 and maintain the state of charge (SOC) within a predetermined range (for example, a range of 0.5 or more to 0.9 or less).

The lower portion of FIG. 5 schematically shows an example of the temporal change in the maximum height (MH) determined based on the state of charge (SOC) and the flight altitude (FH).

The controller 4a according to this example embodiment is configured or programmed to determine the maximum height (MH) to which the multicopter 10 can descend to the ground (GR) and land using the power stored in the battery 52 when power is not being generated by the electric generator 8. The controller 4a is configured or programmed to then control the upper limit of the flight altitude (FH) to be at or below the maximum height (MH). In this way, the controller 4a can change the upper limit of the flight altitude of the multicopter 10 according to the charging state of the battery 52. The upper limit of the flight altitude (FH) only needs to be at or below the maximum height (MH) and does not need to be set to a value equal to the maximum height (MH).

There may be cases where the maximum height (MH) calculated based on the state of charge (SOC) is higher than the altitude regulation value determined by some law. In the lower portion of FIG. 5, the height of the altitude regulation value is shown by a broken line. When the maximum height (MH) is higher than the altitude regulation value, the flight altitude (FH) (shown by a dot-dash line) is limited not by the maximum height (MH) but by the altitude regulation value. In the example of FIG. 5, the maximum height (MH) when the state of charge (SOC) reaches 0.9 exceeds the regulation value.

Note that the maximum height (MH) is preferably determined based on the remaining charge (RC) rather than the relative SOC(=RC/FCC) in a strict sense.

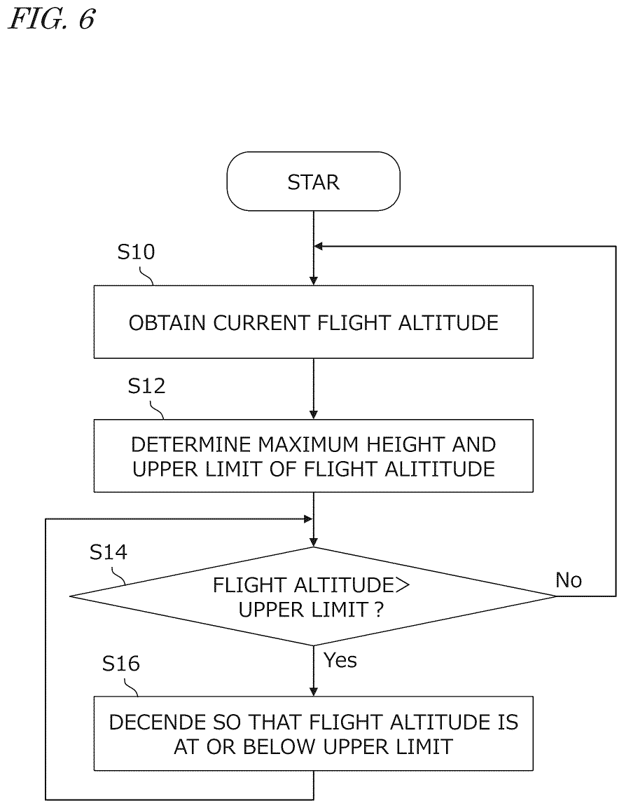

Referring to FIG. 6, an example of the operation of the controller 4a will be explained. FIG. 6 is a flowchart showing an example of the operation of the controller 4a.

First, after starting the operation mode that controls the flight altitude based on the battery's charging state, in step S10, the controller 4a obtains the current flight altitude (FH) of the multicopter 10 from an altitude sensor or the like. In step S12, the controller 4a obtains the state of charge (SOC) (estimated value) from the battery management system 54. At this time, the controller 4a may also obtain other state variables that define the charging state from the battery management system 54 or other sensors. Examples of other state variables may include state of health (SOH) (estimated value) and battery temperature.

In step S12, the controller 4a determines the maximum height (MH) based on the state of charge (SOC). For example, if it is calculated that the multicopter can descend and land on the ground from a flight altitude (FH) of 150 m when the state of charge (SOC)=1.0, and the state of charge (SOC) obtained from the battery management system 54 is 0.8, then the maximum height (MH) is 150×0.8 m. If the state of health (SOH) of the battery 52 is estimated, the maximum height (MH) may be corrected by multiplying by the state of health (SOH). For example, if the full charge capacity (FCC) of the battery 52 has decreased to 0.9 times its initial value, the state of health (SOH) is 0.9, so the maximum height (MH) may be corrected to 150×0.8×0.9 m. As mentioned earlier, the power consumption required to descend a unit length may also depend on the payload and weather conditions including wind speed and air temperature. Therefore, the maximum height (HM) may be corrected based on information related to payload and weather conditions. The controller 4a may obtain necessary information for these corrections from a memory that stores tables or functions. Note that the payload may include the weight of the multicopter 10 itself, the weight of cargo being transported by the multicopter 10, and the weight of various machines such as implements (for example, agricultural implements) connected to the multicopter 10.

The controller 4a can, after obtaining the payload value by the above method, estimate the increase in power consumption according to the payload value and correct the maximum height (HM).

The controller 4a determines the upper limit of the flight altitude (FH) in step S12 such that it does not exceed the maximum height (MH). The upper limit of the flight altitude (FH) is set, for example, within a range that does not exceed the altitude regulation value specified by law. It may also be corrected based on various information such as terrain information below the multicopter 10 during flight. This point will be described later.

The order of the processing steps S10 and S12 described above is arbitrary and they may be executed simultaneously.

Next, in step S14, the controller 4a determines whether the flight altitude (FH) exceeds the above-mentioned upper limit. If Yes, in step S16, the multicopter 10 is descended so that the flight altitude (FH) is at or below the upper limit. If No, after a predetermined time (for example, 10 milliseconds) has elapsed, the process returns to step S10.

By the above processing, the controller 4a is able to descend and land the multicopter 100 by driving the plurality of first rotors 12 with the power stored in the battery 52 when the internal combustion engine 7a stops during flight.

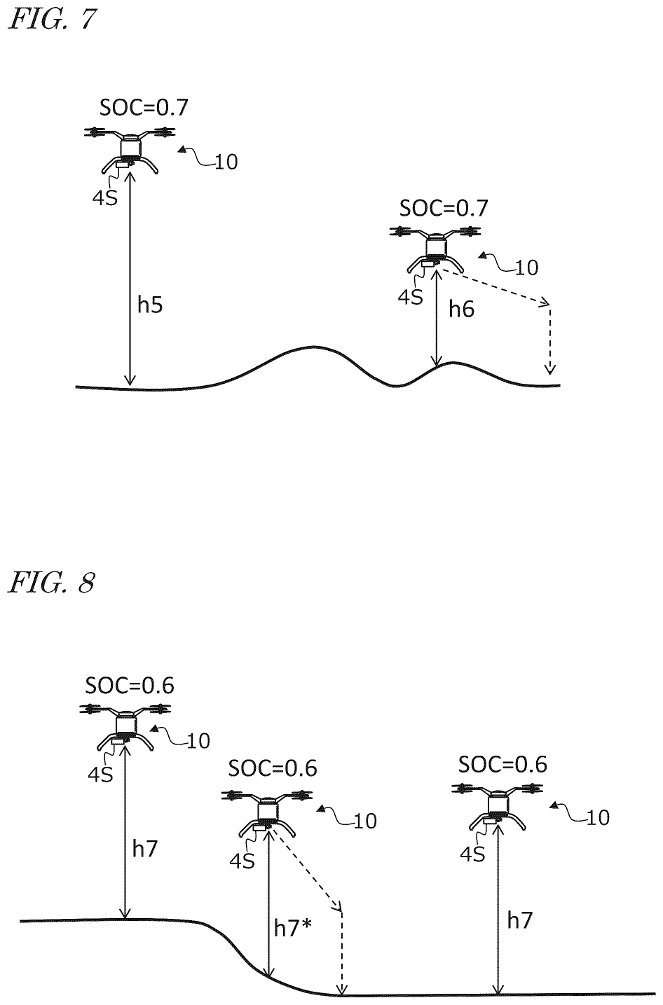

Next, with reference to FIGS. 7 and 8, examples will be explained where the controller 4a corrects the upper limit of the flight altitude based on the ground condition.

FIG. 7 schematically shows an example of correcting the upper limit of the flight altitude according to the terrain directly below the multicopter 10 in the case where the state of charge (SOC)=0.7. Specifically, the upper limit is set to h5 when the terrain directly below the multicopter 10 is flat and there is a high possibility of landing safely there. When the terrain directly below the multicopter 10 is ground with a large slope value or unevenness, the upper limit is corrected to a height h6 that makes it possible to move to a flat position around it and land (move along the path of the broken arrow). In order to detect whether the terrain directly below the multicopter 10 is ground with a large slope value or unevenness, or flat ground, it is preferable for the multicopter 100 to include a sensor 4S that monitors the condition of the ground located below the multicopter 100 during flight. The sensor 4S is a sensor included in the sensor group 4b, for example, an imaging device or a laser sensor. By using such a sensor 4S, the controller 4a is able to correct the maximum height based on the ground condition. Instead of using such a sensor 4S to monitor the ground condition, the controller 4a may obtain information about the terrain directly below the flight path from a map information of the flight area.

FIG. 8 schematically shows another example of correcting the upper limit of the flight altitude according to the terrain directly below the multicopter 10 in the case where the state of charge (SOC)=0.6. In this example, the controller 4a is configured or programmed to adaptively correct the upper limit of the flight altitude based on terrain information. When the multicopter 10 flies over airspace above an area difficult to land such as steep slopes, the controller 4a calculates the time or power required to land on a landable flat ground ahead and lowers the multicopter 10. For example, if the upper limit of the flight altitude over flat ground is at height h7, the upper limit can be lowered to height h7* over the slope. The magnitude of height h7* is calculated so that the multicopter 10 at height h7* relative to the slope can land on the flat ground ahead.

Note that the lower limit of the flight altitude may be set so that the distance from structures on the ground is equal to or greater than a predetermined value (for example, 30 m).

The above operation relates to emergency landing in case power generation by the electric generator 8 stops. Below, an example of transitioning to an emergency “landing point movement mode” when power generation by the electric generator 8 is possible will be explained. “Landing point movement mode” is a mode for moving to a landable point using the driving force of the internal combustion engine 7a and landing there. The operation of flight and landing by this mode is automatically executed by the operation of the controller 4a.

Let the time that can be flown with the fuel loaded on the multicopter 10 and the power stored in the battery 52 be Y [minute]. On the other hand, the time required to fly to the airspace above the nearest landable point a distance X away and complete landing (flight landing time Tfd) is shown by the following equation (1), as mentioned earlier.

$$Tfd = X / ( 60 \times Sf ) + 3 \qquad ( Equation 1 )$$

Here, it is assumed that the multicopter flies distance X at an average flight speed Sf and lands in 3 minutes, for example. The 3-minute time can be set to a different value depending on the multicopter 10.

In this example embodiment, the flight of the multicopter 10 is executed so that Y<Tfd does not hold. If Y=Tfd occurs with respect to the nearest landable point, if the flight continues further, the possible flight time Y will decrease, so the state may transition from Y=Tfd to Y<Tfd immediately. To avoid such a situation, when Y=Tfd occurs, it is necessary to fly from the position where Y=Tfd to the nearest landable point and land there. Therefore, in this example embodiment, when Y=Tfd occurs, the work being performed is interrupted and a “landing point movement mode” is activated to fly to the nearest landable point and land there.

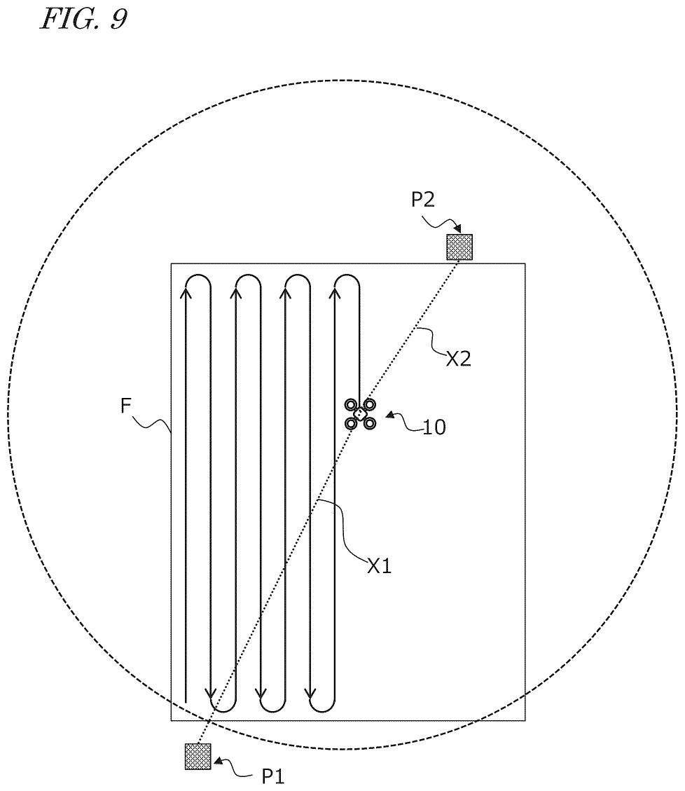

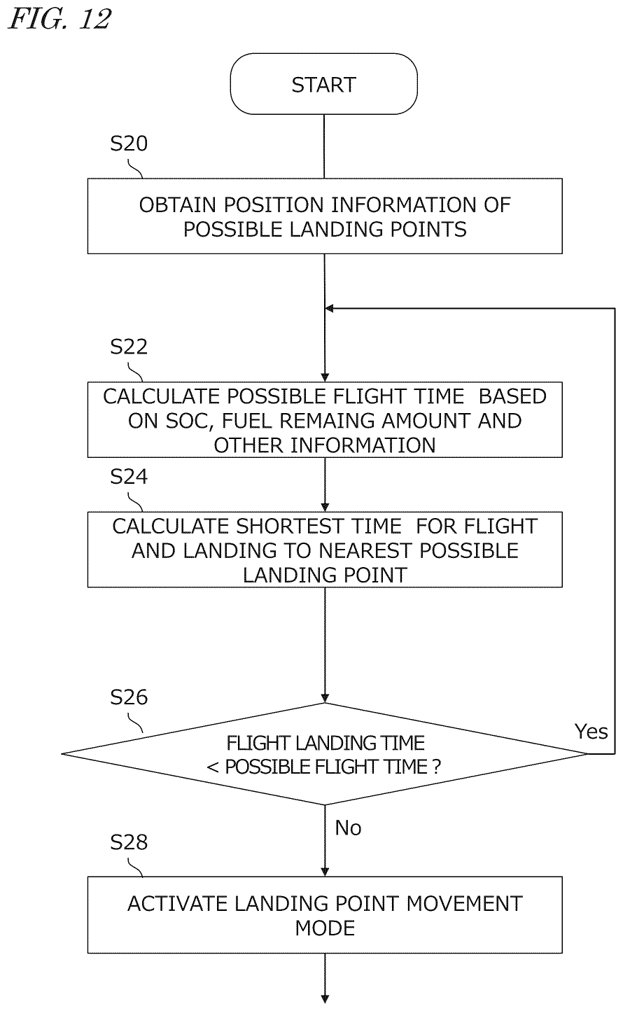

Examples of the landing point movement mode operation will be explained with reference to FIGS. 9 to 12. FIGS. 9 to 11 are plan views showing examples of the positional relationship between a multicopter 10 flying over a field F while working and possible landing points P1, P2 around the field F. FIG. 12 is a flowchart showing an example of the controller's operation for deciding to start the landing point movement mode.

First, referring to FIG. 9. The broken circle centered on the multicopter 10 shows the maximum range (Distance To Empty: DTE) that the multicopter 10 can fly with the possible flight time Y. Note that when wind is blowing in a constant direction, the maximum range that the multicopter 10 can fly with the possible flight time Y is represented not by a true circle but by an oval shape that is deformed according to the wind speed.

The multicopter 10 according to this example embodiment may perform agricultural work such as agricultural chemical spraying while flying over the field F. In FIG. 9, the arrow line shown within the field F schematically shows the flight path that the multicopter 10 has passed through by autonomous driving mode. When the multicopter 10 performs agricultural work in this way, it often flies along a predetermined path above the work area such as field F. However, the work that an agricultural multicopter 10 can perform is not limited to such examples and may include work performed over a wide area including multiple fields, such as the supply and transport of agricultural materials, transport of harvested crops, monitoring of crop growth conditions, surveying, and map creation. Note that when the multicopter 10 transports agricultural materials or harvested crops, for example, the multicopter 10 may fly automatically or autonomously, or by remote control, over airspace of areas other than fields (including areas such as forests and rivers).

In the example of FIG. 9, there is a first possible landing point P1 at a distance X1 from the multicopter 10, and a second possible landing point P2 at a distance X2 from the multicopter 10. Distances X1 and X2 change depending on the position of the multicopter 10. Also, since the possible flight time Y decreases while the multicopter 10 is flying, the radius of the broken circle decreases with the passage of time. For simplicity, the figure shows the lines defining distances X1 and X2 as dotted straight lines, but the lines defining distances X1 and X2 may include curves. The multicopter 10 may need to fly along a path including curves to reach a landable point, for example, when it is required to fly around a no-fly zone or structures such as towers. In such a case, the distance is calculated along such a path.

In the example of FIG. 9, the time (flight landing time Tfd₂) to fly from the current position of the multicopter 10 to the second possible landing point P2 and land is shorter than the time (flight landing time Tfd₁) to fly to the first possible landing point P1 and land. In other words, the possible landing point closest to the current position of the multicopter 10 is the second possible landing point P2. And in the example of FIG. 9, Y>Tfd₂ holds. That is, the possible flight time Y is longer than the flight landing time Tfd₂ to the second possible landing point P2, which is the shortest distance from the current position of the multicopter 10. Therefore, the multicopter 10 continues flying and working.

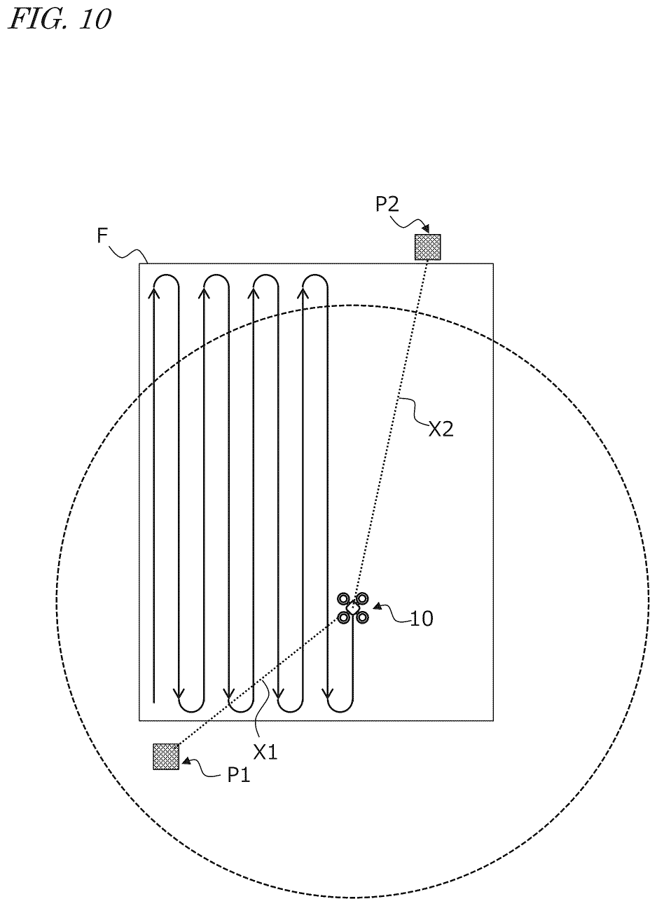

Next, referring to FIG. 10. FIG. 10 schematically shows the state after the multicopter 10, which was at the position in FIG. 9, has continued flying and working. In the example of FIG. 10, the time (flight landing time Tfd₁) to fly from the current position of the multicopter 10 to the first possible landing point P1 and land is shorter than the time (flight landing time Tfd₂) to fly to the second possible landing point P2 and land, and Y>Tfd₁ holds. Therefore, the multicopter 10 continues flying and working.

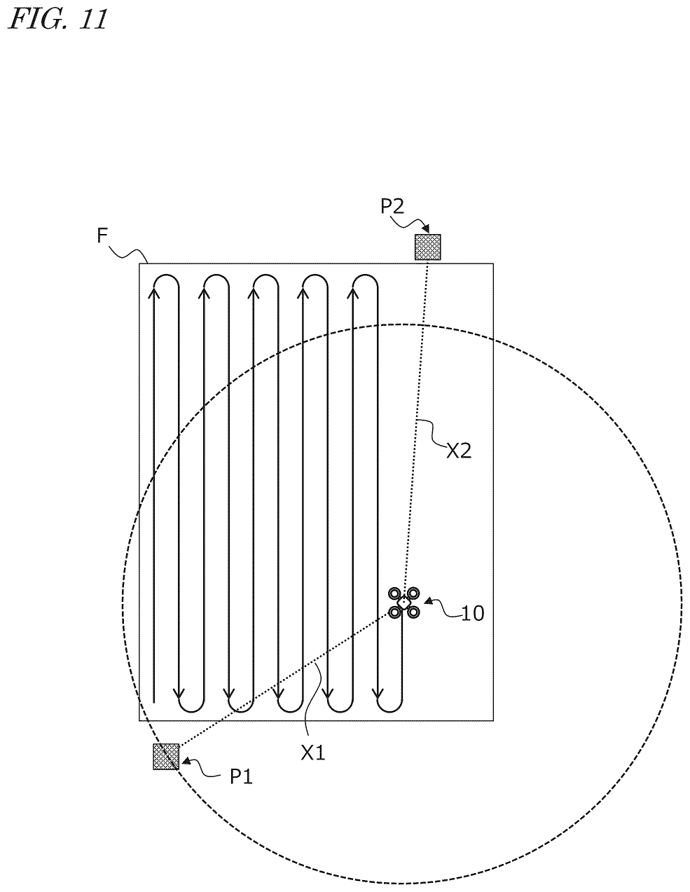

Next, referring to FIG. 11. FIG. 11 schematically shows the state after the multicopter 10, which was at the position in FIG. 10, has continued flying and working. In the example of FIG. 11, the time (flight landing time Tfd₁) to fly from the current position of the multicopter 10 to the first possible landing point P1 and land is shorter than the time (flight landing time Tfd₂) to fly to the second possible landing point P2 and land, and Y=Tfd₁ holds. Therefore, the multicopter 10 interrupts the work and activates the “landing point movement mode”. Specifically, it flies from the current position of the multicopter 10 shown in FIG. 11 toward the first possible landing point P1. After reaching the airspace above the first possible landing point P1, the multicopter 10 starts the landing operation and lands at the first possible landing point P1. In this example, the multicopter 10 that has landed at the first possible landing point P1 has consumed almost all the fuel stored in the fuel tank 7b and the power stored in the battery 52.

The number of possible landing points is not limited to two, and may be one or three or more. Also, the possible landing points need not be narrow sites in the form of spots, but may spread out as surfaces or bands. Each possible landing point may be a wide area where multiple multicopters 10 can land simultaneously. Some or all of the possible landing points may include facilities capable of supplying fuel or power to the multicopter 10. The possible landing points may include wireless communication devices or beacons, and configured to transmit or broadcast various information, including the position information of the possible landing points, to multicopters 10 flying in the vicinity. One of the possible landing points may be the starting point of flight.

Next, the operational flow will be explained with reference to FIG. 12.

First, after the controller 4a of the multicopter 10 starts operation (after startup), in step S20, it obtains position information of possible landing points. Examples of position information are not limited to position information in a geographical coordinate system, but may be position coordinates on a surrounding environment map. The position information of possible landing points may be updated during flight.

In step S22, the controller 4a obtains the state of charge from the battery management system 54. The controller 4a also obtains fuel remaining amount and other information from the sensor group. Examples of “other information” may include various information that is effective for determining the possible flight time Y, such as battery temperature, air temperature, humidity, wind speed, and payload. The controller 4a calculates (or estimates) the possible flight time Y based on these values.

In step S24, the controller 4a determines the distance X from the current position to a possible landing point. If there are two or more possible landing points, the distance X is determined for each of the multiple possible landing points. The controller 4a calculates the shortest time (flight landing time Tfd) required for flight and landing to the nearest possible landing point based on the shortest distance X.

In step S26, the flight landing time Tfd is compared with the possible flight time Y, and if the possible flight time Y is longer than the flight landing time Tfd (Yes), the process returns to step S22. If the possible flight time Y is not longer than the flight landing time Tfd (No), in other words, if Tfd=Y, the process proceeds to step S28, interrupts the work, and activates the landing point movement mode.

After activating the landing point movement mode, it is preferable for the multicopter 10 to notify the user, operator, or manager of the multicopter 10 that it is flying in the landing point movement mode and the position information of the target possible landing point.

Thus, according to this example embodiment, when the multicopter 10 is about to run out of fuel, it can automatically fly to a predetermined possible landing point and land at a known location. There are multicopters that fly in a “return-to-home” mode to return to the departure point in cases such as when communication is lost. Such multicopters can only fly within a predetermined distance range from the departure point. However, according to this example embodiment, by preparing landable points in advance, it is possible to expand the flight range while allowing the multicopter to land in a location from which it can be easily retrieved. Also, when the multicopter 10 lands, it has almost no fuel left, allowing for effective utilization of fuel until the time of retrieval.

The controller 4a in the present example embodiment of the present disclosure may be realized by a digital computer system configured or programmed to execute each process explained with reference to FIGS. 6 and 12.

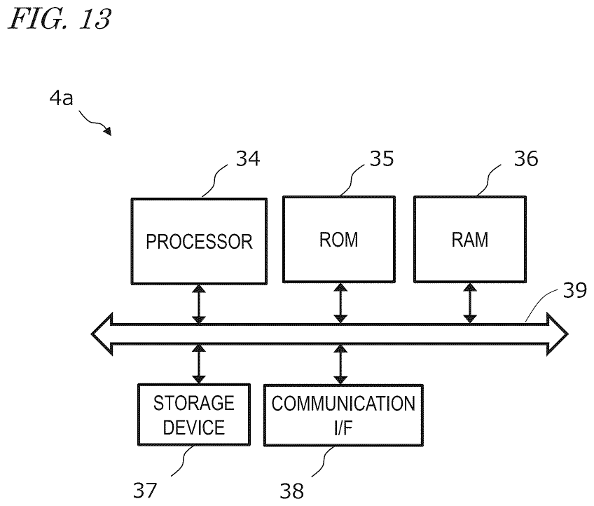

FIG. 13 is a block diagram showing an example of the hardware configuration of the controller 4a. The controller 4a includes a processor 34, ROM (Read Only Memory) 35, RAM (Random Access Memory) 36, storage device 37, and communication I/F 38. These components are interconnected via a bus 39.

The processor 34 may include one or more semiconductor integrated circuits, also referred to as a central processing unit (CPU) or microprocessor. The processor 34 sequentially executes computer programs stored in ROM 35 to implement the aforementioned processing. The term processor 34 may include an FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of a plurality of recording media. Portions of the plurality of collections may be removable memory.

The RAM 36 provides a work area for temporarily expanding programs stored in the ROM 35 during boot-up. The RAM 36 need not be a single recording medium but may be a collection of a plurality of recording media.

The communication I/F 38 is an interface for communication between the controller 4a and other electronic components or electronic control units (ECUs). For example, the communication I/F 38 may perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data useful for autonomous flight of the multicopter 10, and various sensor data acquired by the multicopter 10 during flight.

Note that, as mentioned earlier, the controller 4a may be configured or programmed to include, as separate components, a flight controller such as the flight controller and an upper-level computer (companion computer). The companion computer may execute each of the processes shown in FIGS. 6 and 12 and provide flight-related commands to the flight controller based on the results of those processes.

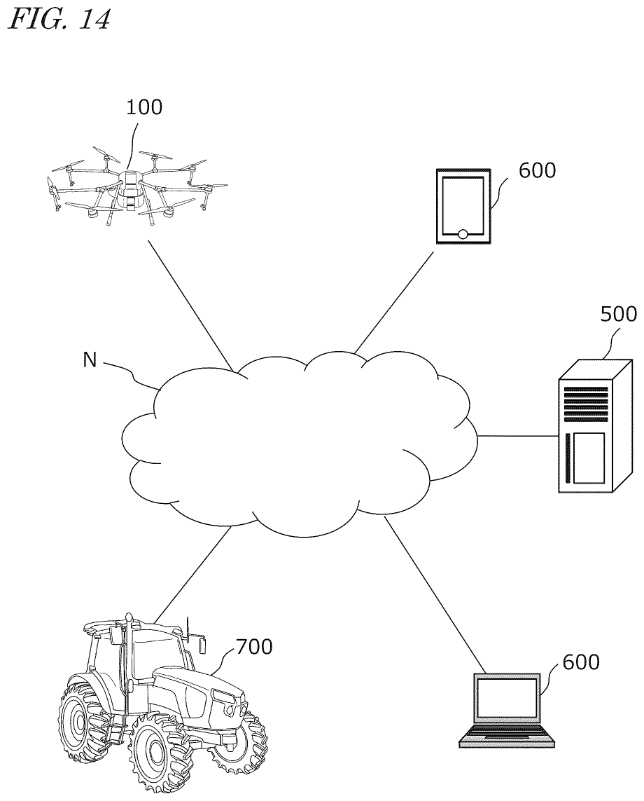

Additionally, one or more servers (computers) 500 or terminal devices (including portable and fixed types) 600 connected to the communication device 4c of the multicopter 100 via a communication network N, as shown in FIG. 14, may execute some or all of the functions of the controller 4a. The agricultural machine 700 such as tractors may be connected to this communication network N, and communication may be performed between the multicopter 100 and the agricultural machine 700. Through the communication network N, portion of the data used for processing by the controller 4a and control signals for the multicopter 100 may be provided to the multicopter 100 from the agricultural machine 700.

Unmanned aerial vehicles according to example embodiments of the present disclosure may be widely utilized not only for aerial photography, surveying, logistics, and agricultural chemical spraying applications but also for ground work related to agriculture, transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle comprising a plurality of rotors, the unmanned aerial vehicle comprising:
a plurality of electric each to drive a respective one of a plurality of first rotors included in the plurality of rotors;
an internal combustion engine;
an electric generator to be driven by the internal combustion engine to generate electric power;
a battery to store the electric power; and
a controller configured or programmed to control flight of the unmanned aerial vehicle and to change an upper limit of a flight altitude of the unmanned aerial vehicle according to a charging state of the battery.

2. The unmanned aerial vehicle according to claim 1, wherein the controller configured or programmed to determine a maximum height to which the unmanned aerial vehicle can descend to the ground and land using the power stored in the battery when power is not being generated by the electric generator, and to control the upper limit of the flight altitude to be at or below the maximum height.

3. The unmanned aerial vehicle according to claim 2, further comprising a battery management system configured or programmed to monitor the battery and to estimate a state of charge that defines the charging state.

4. The unmanned aerial vehicle according to claim 3, wherein the battery management system is configured or programmed to charge the battery with the power generated by the electric generator and maintain the state of charge within a predetermined range.

5. The unmanned aerial vehicle according to claim 3, wherein
the battery management system is configured or programmed to measure a temperature of the battery; and
the controller is configured or programmed to determine the maximum height based on the estimated value of the state of charge of the battery and the measured value of the temperature.

6. The unmanned aerial vehicle according to claim 5, wherein the controller is configured or programmed to obtain a payload value of the unmanned aerial vehicle, and correct the maximum height based on the payload value.

7. The unmanned aerial vehicle according to claim 1, wherein the plurality of rotors includes at least one second rotor driven by the internal combustion engine.

8. The unmanned aerial vehicle according to claim 1, wherein a full charge capacity of the battery has a size that allows the unmanned aerial vehicle to descend from a predetermined reference height to the ground and land using the power stored in the battery when power is not being generated by the electric generator.

9. The unmanned aerial vehicle according to claim 8, wherein the reference height is about 10 m or more and about 300 m or less.

10. The unmanned aerial vehicle according to claim 9, wherein the reference height is about 200 m or less.

11. The unmanned aerial vehicle according to claim 1, wherein the controller, when the internal combustion engine stops during flight, is configured or programmed to descend and land the unmanned aerial vehicle while driving the plurality of first rotors using the power stored in the battery.

12. The unmanned aerial vehicle according to claim 1, further comprising a sensor to monitor a condition of the ground located below the unmanned aerial vehicle during flight, wherein the controller is configured or programmed to correct a maximum height based on the ground condition.

13. The unmanned aerial vehicle according to claim 1, wherein the controller is configured or programmed to acquire information related to weather conditions including wind speed and correct a maximum height based on the information.

14. The unmanned aerial vehicle according to claim 1, wherein the controller is configured or programmed to:
obtain position information of one or more possible landing points;
determine a distance from a current position of the unmanned aerial vehicle to a nearest possible landing point, and based on the distance;
determine a flight landing time required for flight and landing to the nearest possible landing point;
calculate a possible flight time of the unmanned aerial vehicle; and
start an operation for flight and landing to the nearest possible landing point when a predetermined relationship is satisfied between the possible flight time and the flight landing time.
